(19) United States
(12) Patent Application Publication
(10) Pub. No.: US 2011/0318472 A1
(43) Pub. Date: Dec. 29, 2011

(54) LOW FAT CONTENT CHIP-LIKE CEREAL SNACK

(75) Inventors: Stefano Nicoli, Montello (IT); Giovanni Nicoli, Costa Di Mezzate (IT)

(73) Assignee: MOLINO NICOLI S.p.A., COSTA DI MEZZATE (IT)

(21) Appl. No.: 13/138,577

(22) PCT Filed: Mar. 5, 2010
(86) PCT No.: PCT/EP2010/052844

§ 371 Date: Sep. 6, 2011

(30) Foreign Application Priority Data
Mar. 6, 2009 (EP) 09425090.9

(51) Int. Cl. A23L 1/164; A23P 1/02

(52) U.S. Cl. 426/618; 426/454

(57) ABSTRACT

There is described a cereal-based chip-like snack having a very reduced total fat content and an improved shelf-life and a process for the production thereof which comprises the steps of cooking, drying, flaking and toasting. Specifically, chips according to the present invention have size and thickness completely similar to those of the traditional chips. Therefore, they are a highly valid and useful alternative to traditional chips, not only in terms of nutritional and dietetic values, but also in terms of appearance, agreeableness and crispness.

### FIELD OF THE INVENTION

The present invention concerns chip-like cereal snacks having a shelf-life of at least 18 months, wherein the chips consist of flocked pellets of unbroken degerminated cereal grains. Specifically, these snacks are obtained through a process comprising a step of cooking in presence of water and steam, wherein no fats are added and all the nutritionals are kept unchanged. Therefore, the snacks according to the present invention may also be eaten by those people who have to reduce or restrict their daily fat intake, either for health or overweight reasons.

### STATE OF THE ART

Fats and oils supply a very concentrated energy, indeed one gram of fat supplies about 9 kcal per gram. This is more than twice the energy contained in proteins and carbohydrates, both containing 4 kcal per gram. Fat is the best form of energy store. However, in the case of an excessive intake of fats, our body fat deposits increase, thus allowing the body to use them when it is in need. However, a diet too rich in fats may lead to obesity and/or excessively high lipid value in blood (hyperlipidemias). In both circumstances, they are serious risk factors of developing atherosclerosis and diseases related to high rates of cholesterol and triglycerides in blood, which are added to personal, even hereditary, physical pronenesses.

The need and importance of taking care of our diet is increasingly felt, and over time this led to produce several dietetic products wherein the presence of fats has been greatly reduced, sometimes even in favour of other nutritional ingredients, such as vitamins, natural fibres, etc.

Although the fat content of these dietetic products commonly referred to as “light product” is lower than that of the corresponding non-dietetic products, however, sometimes said content is not adequately and enough reduced. In other words, both the caloric level and the fat content of certain dietetic products is not negligible, even when “without added fats” is indicated.

A food product which is well-known to be rich in fats, whose intake is therefore not recommended, is chips, a salty snack in the form of potato “leaves”.

Potato chips are a very widespread product; the habit of crunching potato chips as a snack is certainly a choice incompatible with a correct diet. Indeed, potato chips are one of the most caloric foods, as they supply about 500-530 kcal per 100 g. In addition to the caloric intake, which is too high as compared to the feeling of satiety of potato chips, the most important problem is linked to two related aspects: the oils used for frying and the frying process itself. As regards the first aspect, almost all producers declare the use of general vegetable oils and only sporadic examples explicit the oils employed. The expression “vegetable oil” is very doubtful because mediocre-quality oils are often used for frying, which are obtained by uncertain chemical processes because too stressing for the starting substances. As regards the second aspect, i.e. the frying, it is linked to the two-years-ago warning from Stockholm researchers who detected the presence of acrylamide into fried or baked products. Besides noting that potato chips are not the only incriminated products, it may be said that by limiting the consumption thereof within a hypocaloric diet, the risk of exposing to acrylamide (a carcinogenic substance for rats, but whose dangerousness on humans is to be demonstrated yet) is effectively limited.

Three main factors are pointed out in choosing potato chips:
oils used for frying: not all products explicit the oil used for frying; olive, peanut, palm and sunflower oil which, if refined, has at least the merit to be subjected to a linear manufacturing;
frying mode: even if the process healthiness depends on the frying mode, specifically on the temperature reached by the oil and on how many times the oil is reused, it is really difficult to evaluate this aspect. Indeed, no technical details are available about the industrial process for preparing potato chips;
caloric intake: as already stated, potato chips are very caloric and little satiating.

The caloric intake is given by the oil amount which is absorbed by the potato leaves during the step of frying. There also exist less caloric offers, lower than the typical 500-530 kcal per 100 g, which therefore reduce even the fat percentage, but the other ingredients of which are required to be evaluated. Moreover, it should be noted that many offers do not give any nutritional information.

Therefore, potato chips are a product type which is hardly compatible per se with an usual intake of a hypocaloric and healthy diet, and the market offers also have considerable restrictions and defects. Almost all of them include the use of undeclared vegetable oils, e.g. there are offers which employ general vegetable oil, potatoes and salt, without mentioning those products containing even unrecommended additives, such as monosodic glutamate.

Potato chips referred to as “biological” are known, which are baked instead of being fried and also include ingredients unrelated to the traditional recipe, such as wheat fibre, starch and flour. However, they employ general vegetable oils which increase the caloric intake of the product.

Similar problems are also found in chips made of corn and not fried, because of the use of hydrogenated vegetable fats.

As regards the process for producing potato chips, in addition to frying, the process of extruding-baking is known, a technique which allows to obtain honeycombed and light products. The main steps of extrusion processing are the following. The raw materials, flours or amide and/or protein granulates, appropriately mixed, undergo a pre-conditioning (homogenization, pre-humidification, pre-baking); these are then kneaded with water at 80-100° C. and baked up to 200° C. in a baker-extruder apparatus consisting of a cylinder within which a screw turns, thus causing the mixture to progress at a different pressure depending on the number of revolutions made; the product is then modelled by passing through the holes of a draw-plate and cut to the length desired. The operating conditions of the cylinder, i.e. high pressure and high temperature, do not allow the water to evaporate; therefore, at the draw-plate outlet, a sudden pressure drop occurs, which expands the product due to quick evaporation; the phase change occurs by absorbing heat from the food, the temperature of which decreases to about 80° C. thus solidifying it; the extruded products are finally dried, cooled and added with other ingredients such as salt and flavours, typically carried on the surface of the extruded products by oils of various types. Indeed, oils are required because salt and flavours could not otherwise be kept on the surface of the extruded products themselves. However, using oils necessarily increases the fat content, as well as the caloric intake, of the final product.

Furthermore, as mentioned, the raw materials are flours or various meals, which imply a low content of nutritional substances as compared to the unbroken grains and, above all, imply high contamination and degradation risks as compared to the latter, which risks make their conservation rather tricky.

In this regard, from U.S. Pat. No. 5,904,947 tortilla chips are known being prepared from alkali-treated low digestible fat containing corn dough, i.e. masa. To prepare masa, dried corn is steeped in a water and lime solution (pH=11.2) in a steam-jacketed vessel. The mixture is heated to boiling and then cooled to between 115° F. and 140° F. The corn is allowed to soak for 8 to 24 hours until the moisture content of the corn reaches about 50%. Following steeping, the corn is washed and then uniformly ground or milled into a masa dough. A fat free filler, preferably starch, is added to the milled corn masa and uniformly ground or milled into a dough. The masa dough is sheeted at a thickness of about 0.050″ and 0.060″ and cut into dough pieces. The dough pieces can be partially baked in an oven for 12 to 18 seconds at a temperature between 750° F. and 900° F. to lower the moisture level. The dough pieces are then batch fried in a 5-lb. capacity batch fryer containing frying oil. The frying oil comprises 100% of a sucrose polyester blend comprising about 6% solid nondigestible particles and about 94% liquid soybean oil sucrose polyester. Upon removal from the fryer, they are seasoned for serving. The resulting seasoned tortilla chips are deemed to be digestible-fat free with a nondigestible-fat content of about 26.8% and a moisture content of about 1.0%. However, it should be noted that a dough is prepared by ground or milled corn after a long steeping, and a frying step is performed after a pre-baking step. Therefore, even if this document declares to obtain digestible-fat free corn tortillas, indeed there are many sources of fat in the disclosed preparation, for instance the presence of corn germs, thus increasing the total caloric intake per serving. Additionally, the use of milled corn involves the drawbacks above mentioned with reference to the flours or various meals, as well as accordingly an unsatisfactory shelf-life.

In a subsequently published U.S. patent, i.e. U.S. Pat. No. 6,001,409, corn-based products such as tortilla chips, taco shells, corn chips, soft tortillas, and soft tacos are produced using ground corn products thereby eliminating the need for prolonged steeping times of whole corn kernels, as disclosed in U.S. Pat. No. 5,904,947. The resulting products are deemed to possess a masa flavor and appearance which are comparable to those of products made using a traditional steeping process. In said document, ground corn products rather than whole corn kernels are directly subjected to liming and hydration to substantially reduce steeping times while avoiding the formation of sticky, non-coherent doughs. In the disclosed embodiments, essentially ungelatinized coarse corn particles are substantially hydrated in the presence of lime without substantially gelatinizing the starch. The particle distribution of the coarse corn component is generally such that greater than about 75% by weight, preferably greater than about 95% by weight of the particles do not pass through a 40 mesh screen or sieve. Therefore, this document teaches to grind the corn kernels from the beginning, thus expressly discouraging from using the whole kernels, and additionally to season the resulting tortillas by spraying with oil, having the final oil-sprayed product an oil content of about 15.7% to about 19.6% by weight, based upon the weight of the final product, thus is unavoidably increasing the total fat content and the caloric intake concerned, and at the same time worsening the shelf-life concerned.

A further document, i.e. U.S. Pat. No. 6,491,959, is known which discloses baked, corn-based, chip-like snacks having a plurality of surface bubbles comprising air pockets extending both above and below the substantially unleavened, adjacent portions of the snack are obtained with a pregelatinized waxy starch, a pregelatinized corn flour and baker's bran, that are deemed to overcome the previously cited document U.S. Pat. No. 6,001,409 whose product indeed does not have surface bubbles and surrounding crisp, thin regions. However, also in this case, the snacks are made by a dough of corn flour having a specific degree of gelatinization and by seasoning the final products with vegetable oil and salt. Therefore, even if this document does not teach to fry the dough, however, a corn flour is still used and the seasoning still disadvantageously increases the total fat content and the caloric intake, without improving the shelf-life concerned.

As a matter of fact, it should be noted that, mainly due to the fact that in all these documents the raw materials are flours or various meals, the resulting snack products still imply high contamination and degradation risks thus making their conservation rather tricky and unavoidably not significantly durable, i.e. not exceeding 9 months at best.

It is therefore felt the need for chip-like snacks having a low caloric and fat intake, which are compatible with a healthier and lighter diet behaviour by preserving the all the nutritional substances present in the starting materials, without affecting palatability and crispness, as well as having an improved shelf-life.

Therefore, it is the object of the present invention to find a product which may replace the known potato chips, thus overcoming the nutritional disadvantages related thereto.

### SUMMARY OF THE INVENTION

The aforementioned object has been achieved by a chip-like cereal snack having a shelf-life of at least 18 months, wherein the chips consist of flocked pellets of unbroken degerminated cereal grains.

According to another aspect, the invention concerns a process for producing said chip-like snacks comprising the steps of:
a) providing unbroken degerminated cereal grains;
b) cooking said unbroken degerminated grains in an autoclave in presence of water and steam;
c) drying the so-cooked unbroken grains at a temperature lower than 100° C.;
e) forming the so-dried grains into pellets;
f) flaking the pellets to obtain chips; and
g) toasting said chips.

Such a process allows to obtain a final product that has no added fats, i.e. the only fats present therein are the fats naturally present in the cereals as starting material. Additionally, said process further allows to avoid addition of edible oils which are typically used for preparing chips of the known art, in the case of both frying and baking, as well as for seasoning the same.

### BRIEF DESCRIPTION OF THE DRAWING

The characteristics and advantages of the present invention will be apparent from the detailed description reported below, from the Examples given for illustrative and non-limiting purposes, and from the annexed Figure, wherein the added fat content in known chip-like snacks is depicted in comparison with the zero added fat content of the snacks obtained in accordance with the Examples 1-4 of the present invention.

### DETAILED DESCRIPTION OF THE INVENTION

The subject of the invention is therefore a chip-like cereal snack having a shelf-life of at least 18 months, wherein the chips consist of flocked pellets of unbroken degerminated cereal grains. Specifically, chips according to the present invention have size and thickness absolutely similar to those of the traditional chips, as well as crispy texture and audible crunchy sound upon mastication. Therefore, they are a highly valid and useful alternative to traditional chips, not only in terms of nutritional and dietetic values, but also in terms of appearance, palatability and crispness. Additionally, it has been found that the chips according to the invention advantageously have a shelf-life of at least 18 months, while known chips made by dough of flours or various meals do not exceed 9 months at best. Therefore, the freshness duration of the products is considerably higher and unexpectedly at least doubled.

The chip-like cereal snack according to the present invention preferably has a total fat content lower than 2 wt %. For the purposes of the present invention, with the phrase “total fat content” it is meant the fat content expressed as % by weight based on 100 grams of the snack.

Indeed, the amount of fats in said snack corresponds to the amount of the fats naturally present in the degerminated cereal grains used, therefore advantageously also involving a significantly reduced caloric intake, thus properly compatible with controlled and balanced diets.

According to a preferred embodiment, such a total fat content is of 1.4 to 1.8 wt %, being the fat content of most degerminated cereals falling within said range. Chips having this technical feature represent a food having a considerably high dietetic value, since such a fat content actually is the fat content already present in the starting cereal grains. This means that the resulting chips surprisingly and advantageously have zero added fats. This further means that in addition to the evident advantages in dietetic terms, the consumption of these chips does not cause that sense of heaviness of the digestive system which also typically involves consumer's drowsiness and concentration ability decrease. Moreover, these chips being not greasing for consumer's fingers and, therefore, being more desirable even according to the hygienic-sanitary profile are associated to these great advantages.

Preferably, the cereals of the snacks of the invention are corn, rice, barley, spelt, oats or combinations thereof.

According to a preferred embodiment, the cereals employed are corn, rice or combinations thereof. Indeed, these cereals are advantageously among the most digestible and, as will be seen hereinafter, they proved to be particularly suitable for being processed according to the production process of the invention.

According to a still more preferred embodiment, chip-like snacks of the present invention further comprise salt and suitable flavour enhancers. Thereby, palatability is increased, thus advantageously keeping the fat content of the final product unchanged with respect to the chips as such.

According to another embodiment of the present invention, chip-like snacks according to the present invention further comprise sugar or a sweetening agent, and suitable sweet taste enhancers. Indeed, chips may advantageously be employed not only as an alternative to traditional salty chips, but also as a sweet snack, since the cereals therein are well suited for said combination, specifically in terms of palatability.

In a further aspect, the present invention concerns a process for producing chip-like cereal snacks as above described, comprising the steps of:
a) providing unbroken degerminated cereal grains;
b) cooking said unbroken degerminated grains in an autoclave in presence of water and steam;
c) drying the so-cooked unbroken grains at a temperature lower than 100° C.;
e) forming the so-dried grains into pellets;
f) flaking the pellets to obtain chips; and
g) toasting said chips.

In step a), unbroken degerminated cereal grains are provided, in order to eliminate the outer integuments and the germ from the grains, which could darken during the process, thus altering both taste and appearance of the final product. Moreover, the germ has a high fat content, therefore its removal contributes to significantly reduce the caloric intake of the final product. None of the above cited prior art documents considered this crucial aspect.

In addition, in order to ensure an unaltered content of nutritional substances as compared to the corresponding flours or various meals, above all as compared to the latter, the use of unbroken grains conveniently implies low contamination, degradation and rancidity risks. This is also confirmed by the chips according to the present invention surprisingly and advantageously having a shelf-life not lower than 18 months, while the snack products of the prior art have a maximum shelf-life of 9 months.

In step b), the so-degerminated unbroken cereal grains are cooked in an autoclave in the presence of water and steam. Such a cooking is preferably performed at a temperature of 100 to 200° C. for a period not higher than 180 min, preferably at a temperature of 100 to 150° C. for 110 to 140 min. Since such a cooking is made by water and steam, the above-mentioned properties of unbroken grains are conveniently kept unchanged; on the contrary, in the case of flours or various meals this would disadvantageously not occur. Preferably, the humidity percentage in the autoclave is of 20 to 40%, more preferably of 25 to 35%.

In step c), the so-cooked unbroken grains are dried at a temperature lower than 100° C. Such low temperatures advantageously allow to avoid undesired humidity differences from being established between the grain interior and exterior, which could cause the grains themselves to break.

In step d), the so-dried cereal grains are aggregated into pellets having an average diameter from 5 to 20 mm, preferably from 8 to 15 mm. Such an aggregation is preferably carried out by means of compression.

In step f), pellets are flaked to obtain chips. Through a series of rolling mills, the pellets are preferably calendered in rollers having over water-cooled surfaces to obtain a foil thin enough to be toasted (1.5 mm-2 mm), thus obtaining a better final crispness of no fat chips than the traditional fried chips.

In step g), said chips are toasted, preferably hot-air-toasted. Toasting is preferably carried out at temperatures in the range from 200 to 300° C., in order to reduce the process time. Thereby, the finished chip-like cereal snacks are provided with the crispness and taste agreeableness which make this product a highly valid alternative to the traditional chips, not only in terms of nutritional and dietetic values due to the low fat content.

According to a preferred embodiment, the process according to the present invention further comprises a step h), subsequent to step g), wherein salt, flavours or combinations thereof dissolved in water are sprayed onto said chips, which are then dried. In fact, surprisingly, the seasoning of the chips of the invention can be performed with water, since the crispness and crunchiness have been found to not be affected by the water-spraying and subsequent drying, thus advantageously avoiding the use of any kind of oil, which is known to increase the fat content and the caloric intake of the final snacks.

According to another preferred embodiment, the process according to the present invention further comprises a step d) of tempering to be performed after the step c) of drying and before the step e) of flaking. Such a tempering allows the unbroken cereal grains to rest for the water to homogeneously redistribute between the grain interior and exterior. Such a tempering preferably lasts for about 1 hour.

Examples of the present invention are hereinafter given for illustrative and non-limiting purposes.

### EXAMPLES

### Example 1

500 kg of unbroken corn grains were provided, firstly degerminated and then introduced into an autoclave at a temperature of 130° C. and at a humidity percentage of 30% for a period of 120 min. The so-cooked unbroken corn grains were dried at a temperature of about 60° C. and then allowed to temper for about 1 hour. The dried unbroken grains were compressed and aggregated into pellets of about 10 mm.

Pellets were then flaked so as to take the shape of chips and then toasted at 250° C. for giving them the desired crispness.

### Example 2

1000 kg of unbroken rice grains were provided, firstly degerminated and then introduced into an autoclave at a temperature of 120° C. and at a humidity percentage of 25% for a period of 130 min. The so-cooked rice grains were dried at a temperature of about 60° C. and then allowed to temper for about 1 hour. The dried unbroken grains were compressed and aggregated into pellets of about 13 mm.

Pellets were then flaked so as to take the shape of chips and then toasted at 280° C. for giving them the desired crispness.

### Example 3

800 kg of unbroken corn grains were provided, firstly degerminated and then introduced into an autoclave at a temperature of 120° C. and at a humidity percentage of 35% for a period of 130 min. The so-cooked unbroken corn grains were dried at a temperature of about 80° C. and then allowed to temper for about 1 hour. The dried unbroken grains were compressed and aggregated into pellets of about 8 mm.

Pellets were then flaked so as to take the shape of chips and then toasted at 250° C. for giving them the desired crispness.

Salt and flavour enhancers were dissolved in a minimal amount of water. The so-obtained solution was sprayed onto the surface of the previously produced chips, which were then allowed to dry. Salty and flavoured chips were obtained.

### Example 4

600 kg of unbroken rice grains were provided, firstly degerminated and then introduced into an autoclave at a temperature of 130° C. and at a humidity percentage of 30% for a period of 120 min. The so-cooked unbroken rice grains were dried at a temperature of about 50° C. and then allowed to temper for about 1 hour. The dried unbroken grains were compressed and aggregated into pellets of about 16 mm.

Pellets were then flaked so as to take the shape of chips and then toasted at 260° C. for giving them the desired crispness.

A powder sweetener and sweetness enhancers were dissolved in a minimal amount of water. The so-obtained solution was sprayed onto the surface of the previously produced chips, which were then allowed to dry. Sweet and flavoured chips were obtained.

### Example 5

### Evaluation of Added Fat Content

The added fat content of chips obtained according to the above Examples 1-4 was compared with the added fat content existing in known chips.

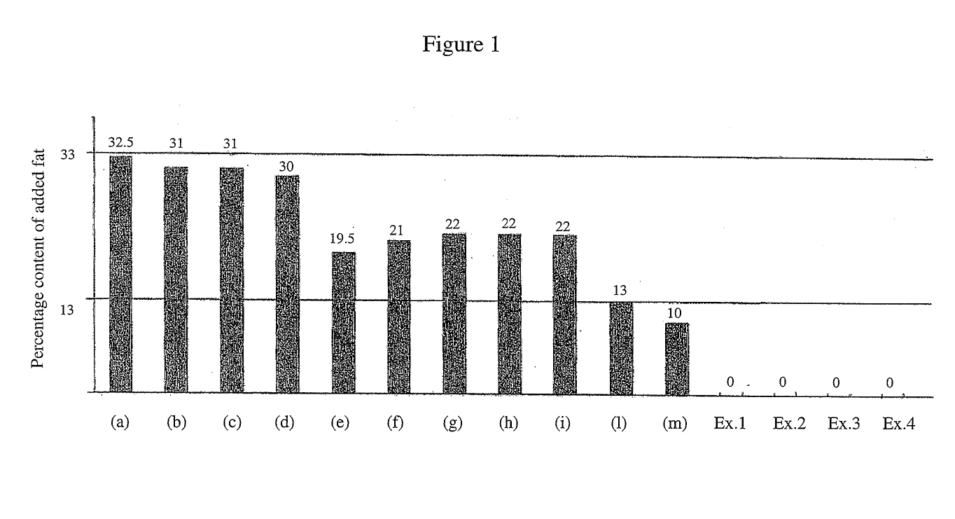

FIG. 1 shows the values of 11 known reference products (a)-(m), while the last value corresponds to the added fat content which was zero for all the four chip-like snacks obtained from the Examples.

The first value (a) refers to traditional fried chips having the highest added fat content.

The second value (b) refers to chip tortillas, the third (c) to corn-and-cheese-based chips and the fourth (d) to corn chips. All three have a still very high added fat content which may actually be compared with that of traditional chips.

The fifth value (e) represents the added fat content in pop-corns, while the sixth (f) refers to another marketed chip tortilla product. Although lower than the previous values, both values are still disadvantageously high.

Products (g)-(i) are marketed as “light snacks”, however their fat content is even higher than that of products (e) and (f).

Products (l) and (m) are both marketed as “light snacks”, being baked instead of fried. In spite of this, the fat content is inevitably high, thus making the caloric intake thereof still significantly large.

Chip-like snacks according to the present invention and made according to Examples 1-4 surprisingly did not contain any added fat.

From the above description and the above-noted Examples, the advantages attained by the product described and obtained according to the present invention are apparent. Specifically, chips according to the present invention have size and thickness which are completely similar to those of the traditional chips. Therefore, they are a highly valid and useful alternative to traditional chips, not only in terms of nutritional and dietetic values, but also in terms of appearance, agreeableness and crispness. Thereby, while both fried and baked traditional chips are typically unrecommended, the chips of the present invention, by being cooked by water and steam, correspond to a snack which is perfectly compatible with a correct diet, even in people suffering from overweight disturbs and/or diseases related to high rates of cholesterol and triglycerides in blood. Additionally, the shelf-life of the snacks of the invention is surprisingly and unexpectedly is at least 18 months, whereas the shelf-life of the known chip-like products do not exceed 9 months at best.

Moreover, there was found a process which allows to advantageously and surprisingly produce these chips completely similar in shape and size to traditional chips, while preventing the fat content in the final product from increasing, but without compromising taste agreeableness and crispness thereof and particularly the preservation of the all the nutritional substances present in the starting materials.

1. A cereal snack consisting essentially of chips and having a shelf-life of at least 18 months, wherein the chips consist of flocked pellets of unbroken degerminated cereal grains.

2. The snack according to claim 1, wherein having a total fat content lower than 2 wt % based on 100 g of the snack.

3. The snack according to claim 2, wherein said total fat content is of 1.4 to 1.8 wt % based on 100 g of the snack.

4. The snack according to claim 1, wherein said cereals are corn, rice, barley, spelt, oats or combinations thereof.

5. The snack according to claim 1, further comprising salt and suitable flavor enhancers.

6. The snack according to claim 1, further comprising sugar or a sweetening agent, and suitable sweetness enhancers.

7. A process for producing a cereal snack according to claim 1, comprising the steps of:
a) providing unbroken degerminated cereal grains;
b) cooking said unbroken degerminated grains in an autoclave in presence of water and steam;
c) drying the so-cooked unbroken grains at a temperature lower than 100° C.;
e) forming the so-dried grains into pellets;
f) flaking the pellets to obtain chips; and
g) toasting said chips.

8. The process according to claim 7, wherein said toasting in step g) is hot-air-toasting.

9. The process according to claim 7, further comprising a step h), subsequent to step g), wherein salt, flavors or combinations thereof dissolved in water are sprayed onto said chips, which are then dried.

10. The process according to claim 7, further comprising a step d) of tempering to be performed after the step c) of drying and before the step e) of pellet forming.

11. The process according to claim 7, wherein step b) of cooking in an autoclave is carried out at a temperature of 100 to 200° C. for a period not higher than 180 min.
